(19) United States
(12) Patent Application Publication
(10) Pub. No.: US 2009/0025012 A1
(43) Pub. Date: Jan. 22, 2009

(54) MASTER DATA COMPLETION FOR INCOMING XML-MESSAGES

(76) Inventor: Bernhard Kelnberger, Rauenberg (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/779,211

(22) Filed: Jul. 17, 2007

(51) Int. Cl. G06F 13/00

(52) U.S. Cl. 719/315

(57) ABSTRACT

A method and system for collaboration in an inventory supply network. Received messages prompt a call to an independent master data competition module. Missing data is resolved independently from the calling service class. The resolve message is then passed to a business object layer to process the message.

### BACKGROUND

1. Field

Embodiments of the invention relate to inventory collaboration. More specifically, embodiments of the invention relate to completion of master data for inbound messages.

2. Background

Upon receiving messages, for example, extensible markup language (XML) messages, a supply network collaboration system often needs certain data, such as parties and locations to process the incoming messages. However, often, some of the required data is missing. In such cases, it is necessary to complete missing data to permit the application to process the message internally. In that light, historically all services have been required to provide their own completion support to ensure that the data that the service requires is present in or resolved from the message prior to attempts by the application to process the message. This effectively increases the complexity of each application. The problem of missing data is particularly acute where multiple unrelated systems are exchanging messages in a supply chain. Collaboration between suppliers in the supply chain is very important.

### SUMMARY OF THE INVENTION

A method and system for collaboration in a supply chain network is disclosed. Received messages prompt a call to an independent master data competition module. Missing data is resolved independently from the calling service class. The resolved message is then processed by a business object layer.

### BRIEF DESCRIPTION OF DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a system of one embodiment of the invention.

FIG. 2 is a flow diagram of an operation in one embodiment of the invention.

FIG. 3 is a flow diagram of rule customization according to one embodiment of the invention.

### DETAILED DESCRIPTION

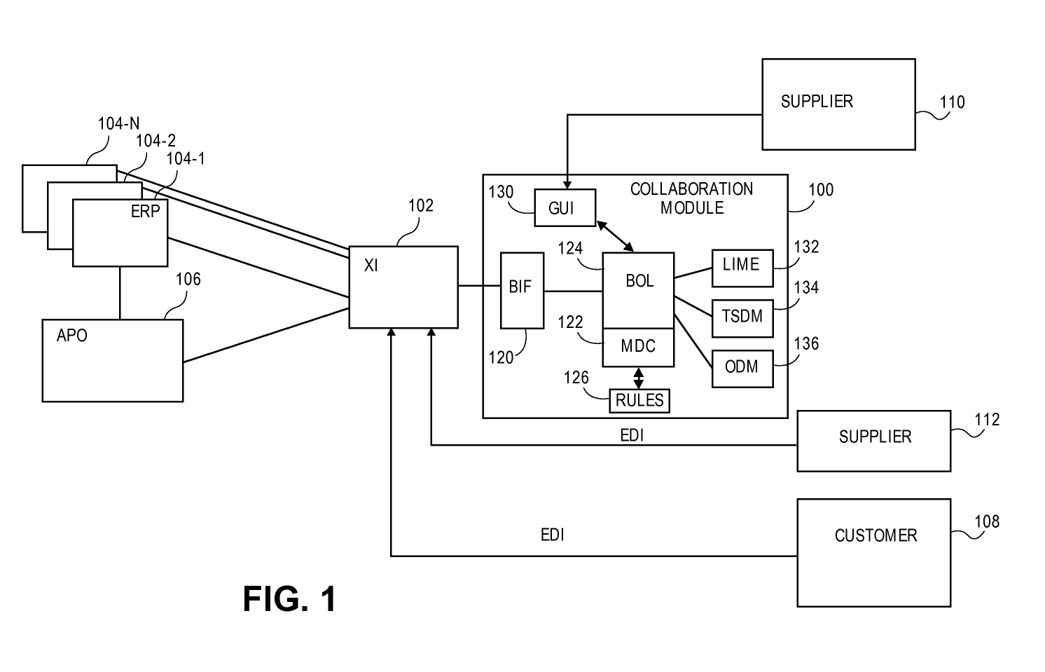

FIG. 1 is a block diagram of a system of one embodiment of the invention. A collaboration module 100 includes a business interface 120, which may communicate with a messaging service 102, such as exchange infrastructure (XI) available from SAP of Walldorf, Germany. Business interface 120 passes received messages to business object layer (BOL) 124. BOL 124 is a collection of service classes. In some cases suppliers 110 may communicate directly with BOL 124 using a web user interface, graphic user interface (GUI) 130. This would commonly be the case for small suppliers without their own electronic data interchange (EDI) link. Other remote entities, such as supplier 112 may communicate through the messaging service 102 to business interface 120 using EDI. Similarly, a customer 108 with an EDI connection may communicate over XI 102 to the business interface 120. Other supply chain participants may use ERP system 104-1, 104-2, 104-N (generically 104), such as R/3 available from SAP of Walldorf, Germany. These ERP systems 104 may, in some embodiments, perform vendor managed inventory (VMI). Some ERP systems 104 may rely on an advanced planner optimizer (APO) 106 also available from SAP AG.

In one embodiment, it is presumed that business interface 120 accepts all messages in extensible markup language (XML) format regardless of the service class to which the message is directed. Stated differently, business interface 120 provides an XML inbound interface for messages directed to any service class of the business object layer 124. Also, within the collaboration module is master data completion module 122 and rule repository 126.

When the business object layer receives a message, any service class receiving the message calls and passes the message to the master data completion module 122. Master data completion module 122 parses incoming XML message to identify what required data is present and what required data is missing. The parsing is independent of the sender and the intended recipient. Thus, master data completion module 122 handles each incoming message generically. Master data completion module 122 then applies rules from rule repository 126 to resolve the required missing data from the remaining data present in the message. For example, if the “ship to” location is present and the product is present, a rule might allow derivation of the “ship from” location which may be required for certain services to process the message. This may occur, e.g., because only a single location ships the product to the destination.

In one embodiment, rule repository 126 includes a set of standard rules and a set of customized rules. The rules may be arbitrarily complexed. In such an embodiment, master data completion module 122 may apply the standard rules first and then resolve any unresolved required data using the custom rules. In one embodiment, master data completion module 122 uses GUI 130 to permit the customization of rules within rule repository 126.

If the master data completion module 122 is able to complete all required data, the business object layer 124 may continue internal processing of the transaction specified by the message. If the completion fails, the BOL 124 terminates processing of the incoming message. As one example, an inbound delivery includes a Buyer Party, Vendor Party, Product Recipient Party, a ship to location, a ship from location and items shipped. However, some applications may additionally need, e.g., a customer location. A rule may exist in the rule repository such as if Buyer Party=X then customer location=Y. Thus, by applying this rule, the master data completion module is able to derive the missing data, customer location from the inbound delivery message prior to passing the message to, e.g., an accounting business object that requires the missing data to perform, e.g., invoicing.

In some embodiments, business object layer 124 communicates with logistic inventory management system (LIME) 132, time series data management model (TSDM) 134, and order data management system (ODM) 136 to conduct the various business transactions. The particular module accessed depends on the type of transaction being conducted.

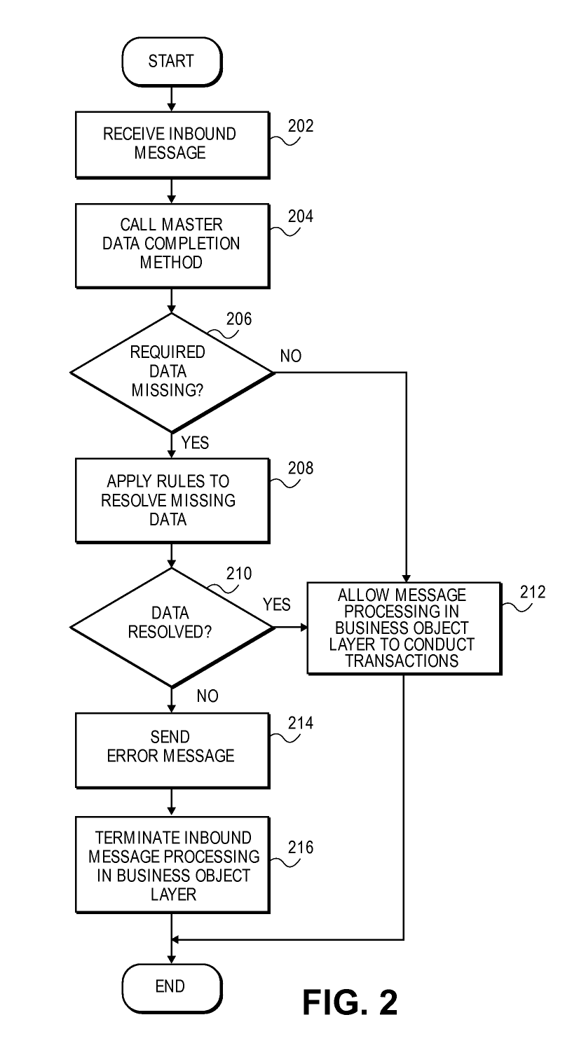

FIG. 2 is a flow diagram of an operation in one embodiment of the invention. At block 202, an inbound message is received. The inbound message may be from an arbitrary service class. The call is made to a master data completion method at block 204. At block 206, the master data completion method determines whether required data is missing. If there is required data missing, a set of rules may be applied to resolve the missing data at block 208. A determination is made at block 210 whether the data has been successfully resolved. If the data has been successfully resolved, the business object layer is permitted to complete processing of the message to conduct a transaction. If the master data completion module fails to resolve the message, an error message is sent back to the original source of the message at block 214 and the business object layer terminates inbound message processing at block 216.

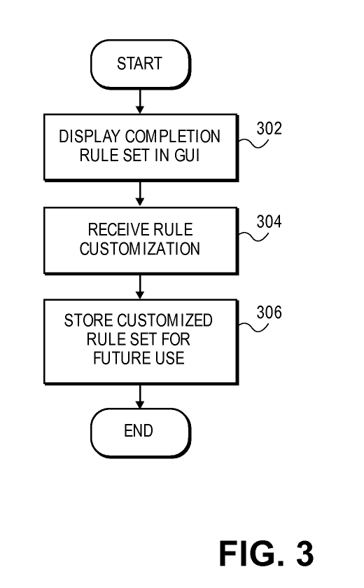

FIG. 3 is a flow diagram of rule customization according to one embodiment of the invention. At block 302, a rule set is displayed in a graphical user interface. At block 304, the user interface receives rule customization. The customized rule set is stored for future use at block 306.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
accessing a master data completion module responsive to receipt of a message directed to an arbitrary service class; and
resolving a set of required data in the message independent of the calling service class.

2. The method of claim 1 wherein resolving comprises:
returning an error if the required data cannot be resolved.

3. The method of claim 1 further comprising:
identifying in the message present required data and missing required data.

4. The method of claim 1 wherein resolving comprises:
applying a set of rules to identify a missing required data value.

5. The method of claim 1 further comprising:
accepting from a user interface a definition of a set of completion rules.

6. The method of claim 5 further comprising:
displaying a graphical user interface (GUI) to permit customization of a set of completion rules.

7. A system comprising:
an interface to receive a data set corresponding to a business transaction;
a completion module independent of a calling service class to identify data missing from the data set and to automatically supply the missing data; and
a business object layer to process the business transaction.

8. The system of claim 7 further comprising:
a rule repository to retain a set of rules to be applied to obtain the missing data.

9. The system of claim 7 further comprising:
a graphical user interface generated by the completion module to permit customization of a completion rule set.

10. The system of claim 7 further comprising:
a messaging service to provide connection between the interface and a remote node.

11. The system of claim 10 further comprising:
an enterprise resource planning module coupled to the messaging service.

12. A machine readable medium having instructions therein that when executed by the machine cause the machine to:
receive an inbound message directed to an application;
indentify that the message omits some required data for processing by the application; and
derive the required data from data present in the message.

13. The computer readable medium of claim 12 wherein the instructions causing the machine to derive cause the machine to:
apply a set of rules to identify a messaging required value.

14. The machine readable medium of claim 12, having instructions that when executed further cause the machine to:
accept from a user interface a definition of a set of completion rules.

15. The machine readable medium of claim 14, having instructions that when executed further cause the machine to:
display a graphical user interface (GUI) to permit customization of a set of completion rules.

16. The machine readable medium of claim 12, having instructions that when executed further cause the machine to:
return an error if the required data cannot be resolved.
